(19) United States
(12) Patent Application Publication
(10) Pub. No.: US 2020/0013057 A1
(43) Pub. Date: Jan. 9, 2020

(54) COMPUTER SYSTEMS, COMPUTER-IMPLEMENTED METHODS AND SOFTWARE FOR PROCESSING PAYOUTS

(71) Applicant: ISX IP Ltd, Road Town, Tortola (VG)

(72) Inventor: Nickolas John Karantzis, East Melbourne, Victoria (AU)

(21) Appl. No.: 16/495,592

(22) PCT Filed: Mar. 22, 2018
(86) PCT No.: PCT/AU2018/050261

§ 371 Date: Sep. 19, 2019

(30) Foreign Application Priority Data
Mar. 23, 2017 (AU) 2017901038

(51) Int. Cl. G06Q 20/40; G06Q 20/12; G06Q 20/20; G06Q 20/10; G06Q 20/36

(52) U.S. Cl. CPC G06Q 20/40; G06Q 20/12; G06Q 20/3674; G06Q 20/102; G06Q 20/20

(57) ABSTRACT

The present disclosure relates to a payout processing system (200). The payout processing system (200) comprises a data store (210) to store details of transactions. A processor (420) communicates with the data store (210). The processor (420) receives a request (222) for a payout from a merchant (120) to a customer (110). The request for the payout comprises a customer identifier and a payout value. The processor (420) also identifies, via the details (232) of transactions in the data store (210), previous transactions to the merchant from a customer associated with the customer identifier. The processor (420) selects previous transactions to the merchant (120) from the customer (110) for refund as part of the payout from the merchant (120) to the customer (110) based on the details of transactions to the merchant (120) in the data store (210). The processor (420) also submits a request for refund (226) from the merchant (120) to the customer (110) of each of the selected previous transactions as part of the payout from the merchant (120) to the customer (110).

### CROSS-REFERENCE TO RELATED APPLICATIONS

The present application claims priority from Australian provisional patent application 2017901038 filed on 23 Mar. 2017, the content of which is incorporated herein by reference.

### TECHNICAL FIELD

The present disclosure relates to computer systems, computer-implemented methods and software for processing payouts. For example, the payouts may be earnings or winnings for trading or games of chance or skill.

### BACKGROUND

Widespread availability and use of computer systems and the Internet have resulted in electronic financial transactions becoming commonplace. The use of payment instruments to purchase goods or services from online merchants or vendors is convenient. For example, users may use a range of payment instruments such as credit cards, debit cards, charge cards, store cards, virtual cards, pre-paid cards, digital currency, eWallets, mWallets and bank accounts.

Similarly, a person is required in the first instance to fund their trading, betting or wagering with an online operator via a funding source that may include electronic payment transactions that use a debit or credit card, a prepaid card, virtual card, digital currency, an eWallet such as Paypal or Skrill, direct bank transfer, direct deposit, direct debit or other means.

FIG. 1 illustrates an example of data connections between parties involved in an electronic transaction. A customer 110 may connect to a merchant 120 to perform a transaction with the merchant 120 for goods and/or services. A financial instrument, such as a card, is processed by the merchant 120 to pay for the goods and/or services by submitting an authorisation request to a merchant acquiring institution (acquirer) 130, who in turn submits an authorisation request to an institution 140 that issued the financial instrument, such as a card issuing institution.

The merchant 120 may have multiple acquirers 130 to whom it submits requests for authorisation, and the merchant 120 may change acquirers within a territory, for example based upon manual operator configuration, usually on a daily basis. The merchant 120 may also have one or more merchant accounts with an acquirer 130, with each such account allocated a merchant identifier (MID) and in some cases, each MID may have multiple terminal identifiers (TID) which identify different points of sale (POS) of workstations associated with the MID.

While the convenience associated with electronic payment transactions is beneficial to customers, it has also led money laundering by criminal gangs, and funding of terrorists. To attempt to address this problem, Anti Money Laundering (AML) and Counter Terrorism Financing (CTF) regulations require that persons be identified if certain monetary or value thresholds have been exceeded during the course of transactions.

The wide use of the internet, together with mobile devices, has given rise to compound annual growth of electronic transactions, which now has resulted in billions of remote electronic financial transactions being conducted via the internet each year. The requirement for identification of persons remote to the merchant making payment via electronic financial transactions is becoming more difficult to satisfy due to speed, distance, complexity and customers and merchants being connected across a global network.

Once a person has been identified, a person that has made earnings or winnings from an online operator normally requires their earnings or winnings to be paid out. The payout process can be costly to the online agency, and the payout can take several days to be available to the person. Usual payout methods may include SWIFT transfer, bank to bank transfer, and original credit transfer (OCT) via the credit card network. Sometimes alone, or in combination with these methods, the bet or wager amount that was placed, before the bet or wager was subsequently won, may be refunded back to an eWallet source, or a virtual card, a prepaid card, a debit card or a credit card (“Card”) that was used to place the bet or wager.

A refund of a transaction may require significant manual effort to determine the source of funds in each case. For example, if the source was a card, the acquirer and MID used in the authorisation needs to be determined. Further, it is not always possible for a merchant to refund a specific transaction as acquirers usually only allow a maximum value of refunds in a given period. This maximum value is usually up to five percent (5%) of the month's rolling processed authorisation total for that acquirer or MID.

The use of cards online has also led to a rise in Card Not Present (CNP) fraud, which are usually typified by “chargebacks”. Chargebacks are presented in two categories, either as 3rd party fraud, due to a lost or stolen card, or as “friendly” or “I didn't do it” fraud, where the cardholder themselves is perpetrating the fraud by falsely claiming that they did not initiate the payment with the merchant, despite having done so.

Online operators will sometimes find that they are defrauded by a customer using a CNP “friendly” chargeback for transactions via a card used to fund a bet, wager or trade. This may cause significant financial loss for the online operator, particularly if a customer receives a payout to a non-card account and then claims a CNP chargeback for the transactions associated with the bets or wagers placed, prior to a win being paid out.

There is therefore a need to reduce processing time for payouts and make online payment systems less vulnerable to CNP chargebacks.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

A payout processing system is provided. The system comprises a data store to store details of transactions and a processor in communication with the data store. The processor is configured to perform the following:

receive a request for a payout from a merchant to a customer, the request for the payout comprising a customer identifier and a payout value;

identify, via the details of transactions in the data store, previous transactions to the merchant from a customer associated with the customer identifier;

select previous transactions to the merchant from the customer for refund as part of the payout from the merchant to the customer based on the details of transactions to the merchant in the data store; and submit a request for refund from the merchant to the customer of each of the selected previous transactions as part of the payout from the merchant to the customer.

The payout processing method may reduce processing time for payouts, as refunded transactions may be processed to a customer's account almost immediately without the complicated authentication process that is required for a new transaction. Further, when a transaction is refunded in full, it is closed out, thus eliminating any chargeback opportunity. The payout processing method may therefore mitigate CNP fraud, because the payout comprises refunds of previous transactions that may have been open being charged back if the payout was made using an OCT to a card, or was made to a different account via a different means, including SEPA, SWIFT or bank to bank transfer.

The processor may be configured to:

identify, via the details of transactions from the data store, one or more acquirers associated with the previous transactions to the merchant from the customer;

calculate, based on the details of transactions stored in the data store, a maximum available refund from the merchant for each acquirer; and

select the selected previous transactions based on the maximum available refund.

The processor may be configured to calculate the maximum available refund from the merchant for each acquirer by:

determining an acquirer aggregate transaction value for the merchant by summing a transaction value of each of the transactions to the merchant that are associated with the acquirer within a refund window period;

determining an acquirer aggregate refund value by summing the amounts refunded from the merchant that are associated with the acquirer within the refund window period; and calculating the maximum available refund from the merchant for each acquirer as:

acquirer refund limit (%)×acquirer aggregate transaction value−acquirer aggregate refund value.

The processor may be configured to calculate a maximum available refund from the merchant for each acquirer by:

calculating, based on the details of transactions stored in the data store, a maximum available refund per merchant identifier (MID) of the merchant for each acquirer.

The processor may be configured to:

generate an array of the previous transactions to the merchant from the customer; and

sort the array by MID associated with each previous transaction from highest to lowest based on the maximum available refund for each MID; and

select the selected previous transactions to the merchant from the customer according to the sorted order of the array.

The processor may be configured to:

sort the array by transaction value of each previous transaction for each MID from highest value to lowest value; and

select the selected previous transactions to the merchant from the customer according to the sorted order of the array.

The processor may be configured to:

sort the array by a date of each previous transaction for each MID from highest value to lowest value; and

select the selected previous transactions to the merchant from the customer according to the sorted order of the array.

The processor may be configured to:

determine that a sum of the maximum available refund from the merchant for each acquirer associated with the previous transactions is less than the payout value;

and determine at a later time that one or more further transactions to the merchant that are associated with the one or more acquirers have been processed; and submit a request for refund of one or more of the further previous transactions as part of the payout from the merchant to the customer.

The processor may be configured to:

determine that a sum of the transaction values of the previous transactions to the merchant from the customer is less than the payout value, and submit a request to transfer of a remainder of the payout value from the merchant to the customer.

The processor may be configured to automatically submit a request to transfer the remainder of the payout value via an original credit transfer (OCT) to a card to a card associated with one of the previous transactions.

The processor may be configured to automatically submit a request to transfer the remainder of the payout value via an alternative payment means to an account identified by the customer.

The processor may be configured to submit the request to transfer a remainder of the payout value from the merchant to the customer to one of the following: an acquirer used for a previous transaction associated with the payout request;

a card identified by the customer; and

a bank account identified by the customer.

The processor may be configured to: determine one or more payout means associated with the customer identifier, and identify one or more of the payout means in the request to transfer a remainder of the payout value from the merchant to the customer.

The processor may be configured to:

determine, via the data store, one or more of the following payout details associated with the customer identifier: payment methods, account details, and previous refund means used by a customer to fund payments; and generate the request to transfer a remainder of the payout value from the merchant to the customer based on the payout details.

The processor may be configured to store transaction details in the data store when a transaction is processed.

The processor may be configured to retrieve one or more of the following transaction details from the data store for one or more transactions:

a transaction time;

a transaction identifier;

a customer identifier;

an acquirer identifier;

a merchant identifier; and

a transaction value.

The processor may be configured to retrieve one or more of the following transaction details from the data store for one or more transactions:

a refund value;

a terminal identifier;

an authorisation and authentication code generated by a payment network for the transaction;

a time when the acquirer associated with the transaction was last active;

an account or card identifier; and

a currency used for the transaction.

The payout processing system interfaces with or forms part of a payment network or a transaction processing network.

The previous transactions may be transactions that were processed within a refund period.

A payout processing method to be performed by a computer to execute a payout of a payout value to a customer is provided. The method comprises:

receiving a request for a payout from a merchant to a customer, the request for the payout comprising a customer identifier and a payout value;

identifying, via a data store including transaction details of transactions, previous transactions to the merchant from a customer associated with the customer identifier;

selecting previous transactions to the merchant from the customer for refund as part of the payout from the merchant to the customer based on the details of transactions to the merchant in the data store; and submitting a request for refund from the merchant to the customer of each of the selected previous transactions as part of the payout from the merchant to the customer.

Computer readable media is provided, comprising computer code components that when executed by a processor cause the processor to perform the method as described above where appropriate

Optional features described of any aspect of the computer system, method, computer readable medium, where appropriate, similarly apply to the other aspects also described here.

### BRIEF DESCRIPTION OF DRAWINGS

FIG. 1 illustrates an example of data connections between parties involved in a transaction.

FIG. 2 illustrates a payment system.

FIG. 3 illustrates a payout method.

FIG. 4 illustrates a payout processing system.

FIG. 5A illustrates an array generated by a processor upon request from the merchant for a payout of a payout value to a customer.

FIG. 5B illustrates an example sorted array generated from the array in FIG. 5.

FIG. 6A illustrates example maximum available refunds per acquirer for a first merchant identifier (MID 1) of the merchant.

FIG. 6B illustrates example maximum available refunds per acquirer for a second merchant identifier (MID 2) of the merchant.

FIG. 6C illustrates example maximum available refunds per MID, maximum available refunds per acquirer, and an maximum available refund for the merchant.

FIG. 7 illustrates a first interface to configure aspects of the payout process.

FIG. 8 illustrates a second interface to configure aspects of the payout process.

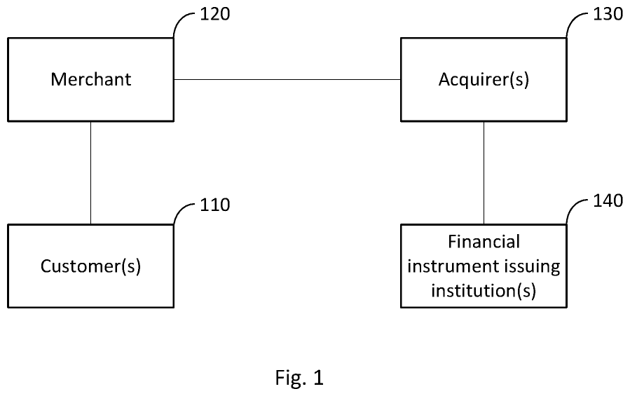

### DESCRIPTION OF EMBODIMENTS

This disclosure describes payout processing systems, methods and software for processing payouts from a merchant to a customer. The payouts may be performed, for example, by online operators of lotteries, casino's, Foreign Exchange (FX), securities, derivatives, binary options, contracts for difference (CFD), spread betting, sportsbetting, wagering, e-gaming and similar regulated and unregulated trading or games of chance or skill. The payout processing systems, methods and software process the payouts in whole, or in part, by refunding previous payments that the customer has made to the merchant. This may reduce processing time for payouts, as refunded transactions may be processed to a customer's account almost immediately without the complicated authentication process that is required for a new transaction. Therefore, a customer may receive all or part of the payout without the authentication delay that a new transaction would incur. The refunding of previous payments may also mitigate CNP fraud, because these payments will no longer be available for chargeback after the payout has been made.

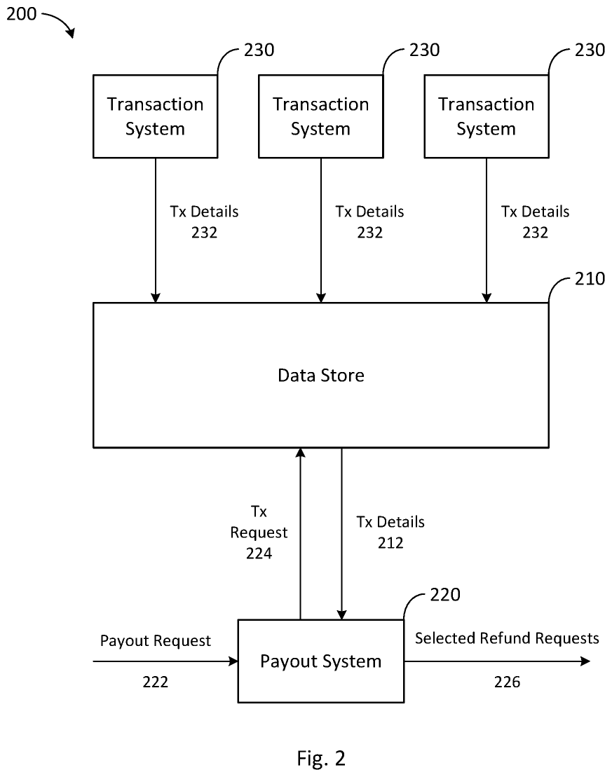

FIG. 2 illustrates a payment system 200 according to one embodiment of the disclosure. The payment system 200 includes one or more transaction systems 230 that process transactions, such as payments to a merchant. When a transaction is processed by any of the one or more transaction systems 230, details 232 of the transaction are transmitted to a data store 210 and stored in the data store 210. The data store 210 may store, for example, one or more of the following details for each transaction: a time at which the transaction was performed (TxTime); a customer identifier (CustlD); a transaction identifier (TXID); a primary account number (PAN); an acquirer identifier (ACQID); a merchant identifier (MID); an amount transferred in the transaction; and one or more amounts refunded from the amount charged.

The data store 210 may also store one or more of the following details for each transaction, for example, according to the implementation of the payment system: a terminal identifier (TID); an acquirer status (ACQSTAT) such as available or offline; a currency used in the transaction; and an authorisation code for access to a payment network used in the transaction.

The details of transactions may provide an up-to-date record of transactions involving, for example, one or more merchants, one or more customers and one or more acquirers. In this way, the data store 210 stores details of transactions for all previous transactions between the merchant and customer. This may include transactions for multiple purchases.

The payment system 200 comprises a payout system 220 in communication with the data store 210 to process payouts. The payout system 220 may receive a payout request 222 to payout a payout value from a merchant to a customer. In some examples the payout system 220 receives the payout request 222 from the merchant. In this way the merchant initiates the payout of the refunded transactions to the customer. In other examples the payout system 220 receives the payout request 222 from the customer. When the payout system 220 receives the payout request, the payout system 220 sends a transaction request 224 to the data store 210, and in response to the transaction request receives details of transactions 212 relating to the merchant and the customer. In some examples the payout system 220 receives details of all previous transactions 212 relating to the merchant and customer. In other examples the payout system 220 receives details of a subset of all previous transactions 212 relating to the merchant and customer. The payout system 220 may then send one or more requests 226 to refund a selection of the transactions between the merchant and the customer to implement the payout, in part or in full. The selection and the refund request 226 may be based on the details of transactions 212 from the data store 210.

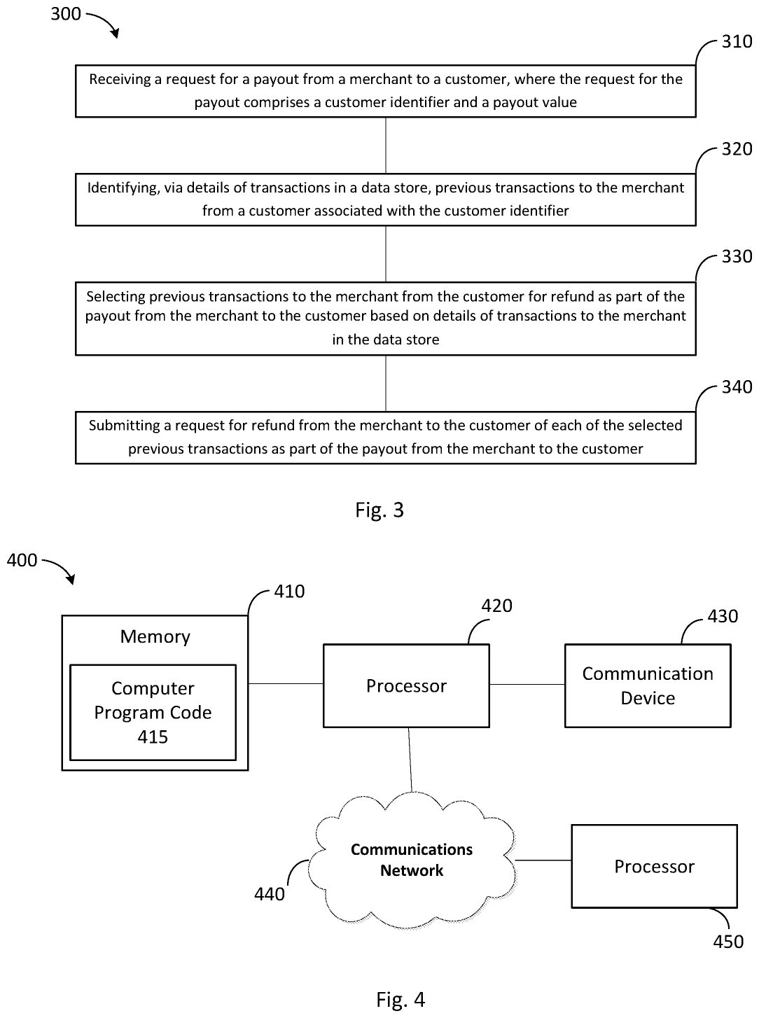

FIG. 3 illustrates a payout method 300 according to one embodiment. In one example, the system 200 implements the payout method 300.

At 310, the method 300 comprises receiving a request for a payout from a merchant to a customer. In some examples the method 300 receives the request from the merchant. In other examples the method 300 receives the request from the customer. The request for the payout comprises a customer identifier and a payout value. The customer identifier identifies the customer to which the payout is requested.

At 320, the method 300 comprises identifying, via details of transactions in a data store such as the data store 210, previous transactions to the merchant from a customer associated with the customer identifier. In some examples the method 300 identifies all previous transactions to the merchant from the customer. In other examples the method 300 identifies a subset of all previous transactions to the merchant from the customer.

At 330, the method 300 comprises selecting previous transactions to the merchant from the customer for refund as part of the payout from the merchant to the customer based on the details of transactions to the merchant in the data store. The method may exclude previous transactions from selection where the previous transaction is unavailable for refund, for example, if an acquirer associated with the transaction is “inactive” and/or unavailable, or if a card associated with the transaction has expired.

At 340, the method 300 comprises submitting a request for refund from the merchant to the customer of each of the selected previous transactions as part of the payout from the merchant to the customer.

FIG. 4 illustrates a payout processing system 400 according to one embodiment. The payout processing system 400 comprises a memory 410 and a processor 420. The memory 410 may comprise non-transitory computer readable media, such as one or more hard drives or solid state disks. In some examples, the non-transitory computer readable media may comprise a local data storage, a distributed data storage and/or a remote data storage.

The memory 410 may store computer program code that when executed by the processor 420 performs aspects of the disclosure described herein. For example, the processor 420 may execute computer program code to perform a payout to a customer from a merchant based on the details of transactions in a data store 210. In some examples, the memory 410 may comprise the data store 210. In some examples, the data store 210 may be in a separate memory to the computer program code.

In some examples, the processor 420 receives the request for a payout to the customer from a processor 450 or communication device associated with the merchant. The processor 450 may communicate with the processor 420 over a communications network 440. As described above the request for a payout includes customer identifier and a payout value. In this way, the processor 420 identifies details of transactions in the data store 210 based on the request received over the communications network 440 by the merchant's processor 450 or communication device.

The processor 420 dynamically determines one or more means of payout to a customer based on the details of transactions stored in the data store 210. In some examples the data store 210 stores details of all previous transactions between the merchant and customer. In other examples the data store 210 stores details of a subset of all previous transactions between the merchant and customer. The processor 420 may also store details of each new transaction and/or payout between the merchant and customer, for example new transactions or payouts associated with a merchant or a payment network, in the data store 210 when a transaction or payout is performed. In some examples, one or more transactions may be contemporaneously stored in the data store 210 while a payout is being processed by the processor 420. The processor 420 may be connected to a communication device 430, such as a network adapter, to communicate with one or more parties, such as merchant(s), customer(s) or acquirer(s), to perform payout(s) and/or transaction(s). In one example, the processor 420 retrieves details of transactions from a data store 210 via a communication device 430.

In one example, the processor 420 determines an acquirer associated with each selected transaction based on the details of the transactions from the data store 210. The processor 420 then submits the request for refund of each selected transactions to the respective acquirer, for example, via the communication device 430. The processor 420 includes the necessary details of the transaction for the refund in or with the request for refund.

The processor 420 may be or form part of a computer, a server, a series of servers, the cloud, a mobile device, a payment network, a processing network, the communications network 440, or any other apparatus or combinations of the foregoing, with suitable computation power to perform the functions described herein, such as analyse, process and transmit the necessary data and metadata. In some examples, the processor 420 may form part of the payout system 220. In other examples the processor 450 forms part of the payout system 220.

### Selecting Transactions for Refund

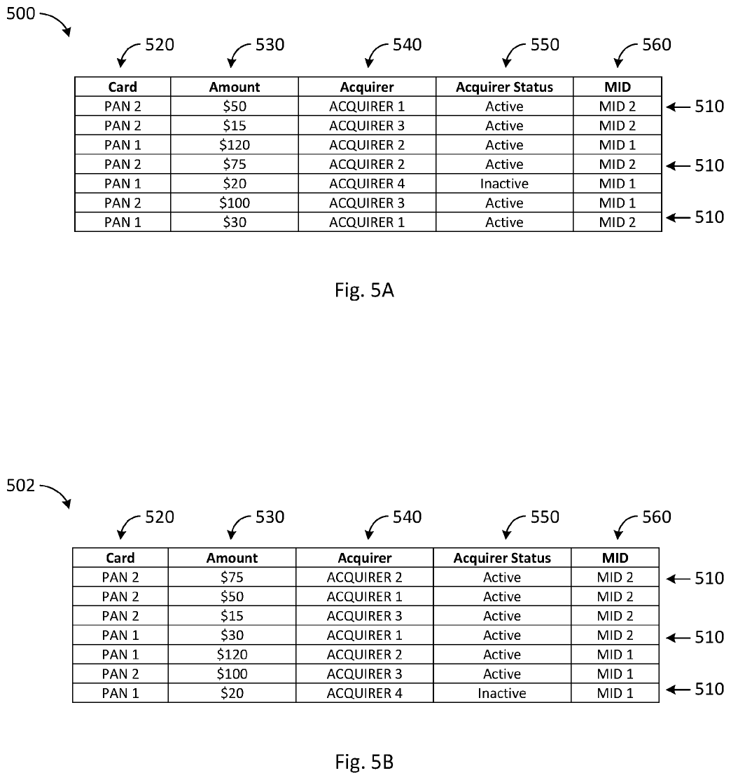

FIG. 5A illustrates an example array 500 generated by the processor 420 upon receiving a request from the merchant or merchant processor 450 for a payout of a payout value to a customer. The array 500 may be stored in the memory 410. The array 500 includes all, or a subset of all, previous transactions 510 between the merchant and the customer. The term “array” as used herein is not intended to limit the disclosure to a certain means of data storage or syntax. For example, the array 500 may be generated and stored as a list of transactions, details of transactions, pointers to transactions, pointers to details of transactions, and/or any other means that enables sorting of transactions based on details of the transactions as discussed below.

The array 500 may be generated by the processor 420 by identifying, via the data store 210, the following details for each transaction 510 between the merchant and the customer: a card 520 used for the transaction, an amount 530 authorised for the transaction minus any refunds already processed against that transaction, a card acquiring institution 540 used in the processing of the transaction, a status 550 of the card acquiring institution, and a merchant account identifier 560. The processor 420 may also identify a terminal identifier (TID), if applicable. The card 520 used for the transaction may be identified by details of the card type of the card and a 16 or 19 digit unique card account or primary account number (PAN) together with expiry date data. These details may be provided back to the acquirer in order to execute a refund. In one example, the processor 420 determines whether the card has expired since the transaction 510 based on the expiry date data, and may exclude the card from selection if the card has expired. The status 550 of the card acquiring institution, may include an indication that the card acquiring institution is “active”, i.e. if the card acquiring institution is technically and commercially available. In some examples, inclusion of the MID in the array may be optional. For example, if only one MID has been issued by the acquiring institution(s) to the merchant and the system only includes transactions for a single merchant.

In some embodiments, the processor 420 may only add transactions 510 to the array 500 that were performed within a predefined refund period, as the acquirer may reject refunds of transactions made outside the refund period. For example, whether the transaction was made within the predefined refund period may be determined by the processor 420 from the transaction time recorded in the details of transactions in the data store 210. The predefined refund period may be three months back from the intended payout date, which is a typical refund period for acquirers after which transactions can no longer be refunded. The payout request and date is usually for instantaneous payout by refund to one or more cards used by the customer to fund services provided by the merchant.

The processor 420 may determine the aggregate value of transactions authorised for the customer against each card used for the transactions with any amount (part) refunded against any transaction deducted.

The processor 420 may sort the array 500 by the MID associated with each transaction from high to low according to the maximum available refund per MID. The processor 420 may then sort or rank transactions processed on each card (or associated with each acquirer) for that MID from high to low, or by another sequence as may be configured by the merchant via an input to the processor 420. In some examples, the processor 420 may sort by a weighted combination of one or more details of the transactions alone or in combination with the maximum available refund per MID. In other examples, the processor 420 sorts the array 500 by transaction value of each previous transaction for each MID from highest value to lowest value. In this way the processor 420 selects the previous transactions for refund according to the sorted order of the array 500. This mitigates chargeback risk for the merchant.

FIG. 5B illustrates an example sorted array 502 where MID 2 has a higher maximum available refund than MID 1. The processor 420 may select transactions for refund to payout the payout value based on the order of the sorted array 502, until such time as the payout sum is exhausted in whole, or, until such time as there is a payout residual remaining. The processor 420 may exclude a transaction from selection if the associated acquirer is “inactive”.

Each acquirer may have a different refund limit, typically per calendar month calculated as a rolling limit in real time. The refund limit may be a percentage of the transactions performed with that acquirer by an entity for the month to date. The memory 410 may store a maximum permissible refund limit per acquirer, ranging from 0% to 100% (e.g. per calendar month or other refund window period). The processor 220 may receive an input from an operator to update the value of a refund limit in the memory 410.

In some examples, the residual occurs due to the aggregate value of transactions from the customer to the merchant processed against one or more MID's or one or more acquirers or both within the predefined refund period being insufficient. In some examples, the residual occurs due to the maximum available refund for the MID's having been temporarily exceeded. In some examples, the residual occurs due to a combination of these factors. The maximum available refund thus may need to be calculated by the processor 420 from the details of transactions in the data store 210 as a point in time exercise.

The processor 420 may be configured to submit a request for refund, from the merchant to the customer, of each of the selected one or more previous transactions as part of the payout from the merchant to the customer. The residual may then be paid out by the merchant using alternative payment means, such as a payment from the merchant to the customer, for example, by SEPA transfer, SWIFT transfer, bank to bank transfer (such as Electronic Funds Transfer), original credit transfer (OCT) via the credit card network, or Automatic Clearing House. The processor 420 may send a request to process the payment of the residual automatically if the customer has provided account details associated with SEPA transfer, SWIFT transfer, bank to bank transfer, or, if one of the previously used unexpired cards may be designated for the OCT. In some examples the processor 420 optimises the payment means depending upon the location of the customer, the amount of the residual or whether there is a requirement to transfer the residual quickly.

In one example, to generate the request for refund, the processor 420 determines one or more payout means associated with the customer identifier. The processor 420 may then identify one or more of the payout means in the request to transfer the residual. In one example, the processor 420 automatically submits a request to transfer the remainder (residual) of the payout value via an original credit transfer (OCT) to a card used for one of the previous transactions. In a further example, the processor 420 submits a request to transfer the remainder of the payout value via alternative payment means to a bank account, or other account, identified by the customer. In this way, the customer provides details of a bank account, wallet, or other account type to which an electronic payment is possible. As described above, alternative payment means includes SEPA transfer, SWIFT transfer, bank to bank transfer (such as Electronic Funds Transfer), original credit transfer (OCT) via the credit card network, or Automatic Clearing House. In some examples the customer selects the alternative payment means based on cost, speed of transfer, reach, or a combination of these and other factors. In further examples the system automatically optimises the selected alternative payment means depending on the location of the customer, the amount of the remainder of the payout value, or whether there is a requirement to effect a transfer quickly.

In another example, the processor 420 submits the request to transfer the remainder of the payout value from the merchant to the customer to one of the following: an acquirer used for a previous transaction associated with the payout request, a card identified by the customer, or a bank account, or other account, identified by the customer. In yet another example, the processor 420 determines, via the data store 210 or the memory 410, one or more payout means associated with the customer identifier. The processor 420 then identifies one or more of the determined payout means in the request to transfer the remainder of the payout value from the merchant to the customer.

In one example, the processor 420 determines, via the data store 210 or the memory 410, one or more of the following payout details associated with the customer identifier: payment methods, account details, and previous refund means used by a customer to fund payments. The processor 420 then generates the request to transfer the remainder (residual) based on the payout details.

If the processor 420 determines that the residual has occurred due to a maximum available refund having been exceeded, then the processor 420 may wait until further transactions are stored in the data store 210 which contribute to the relevant aggregate transaction value. The maximum available refund per MID is a function of aggregate transactions authorised and processed by cards on a specific MID belonging to any customer transacting with the merchant. That is, the maximum available refund is an instantaneous value that increases with each card payment transaction authorised in favour of the merchant at any acquirer originating from any customers, and instantaneously decreases with any refunds processed to any customers. Therefore, the processor 420 may wait, for example, for 15 minutes or until later the same day or until the next day or some other configurable period, and then determine whether any further transactions between the customer and the merchant can be refunded.

### Determining Refund Limits

The processor 420 may calculate, for example based on the current details of transactions in the data store 210, the maximum available refund per entity (e.g. per MID) per acquiring institution. For example, the following formula may be used to calculate the maximum available refund per MID per acquiring institution:

$$Maximum Allowable Refund = RL \% \times {\sum }_{MTD} ( Payments ) - {\sum }_{MTD} ( Refunds )$$

where RL % is the acquirer refund limit (percentage of payments for the month to date),

$${\sum }_{MTD} ( Payments )$$

is me aggregate value of transactions processed for the MID for the month to date, and

$${\sum }_{MTD} ( Refunds )$$

is the aggregate value of refunds processed for the MID for the month to date.

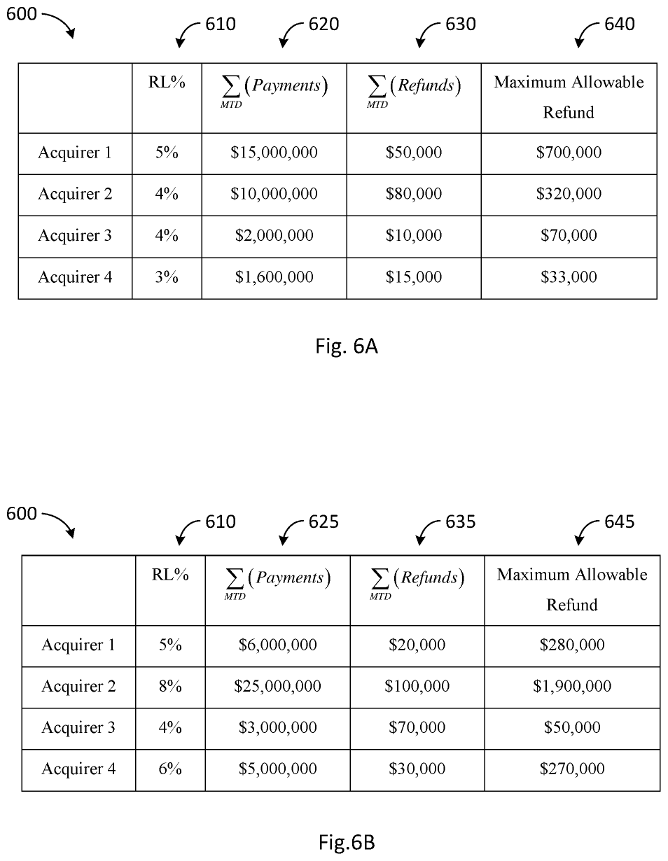

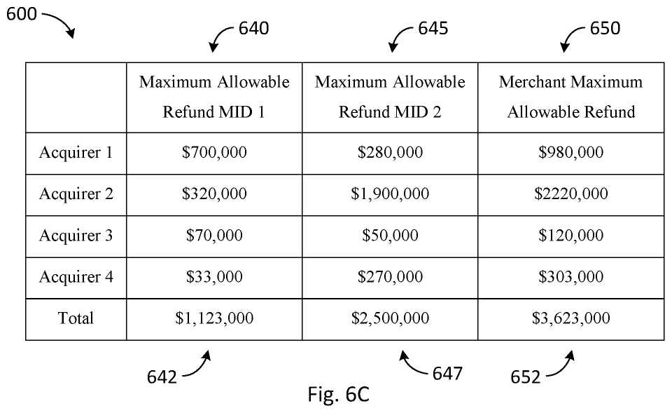

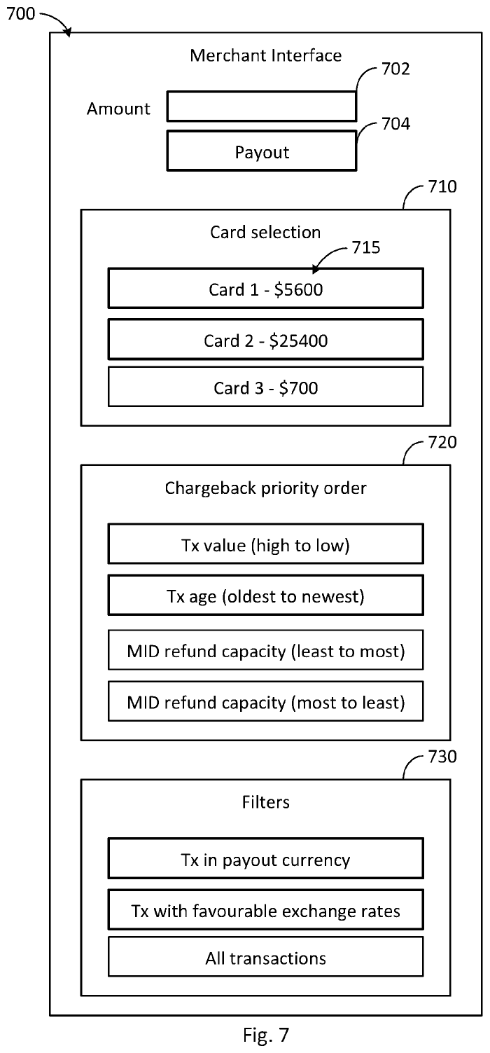

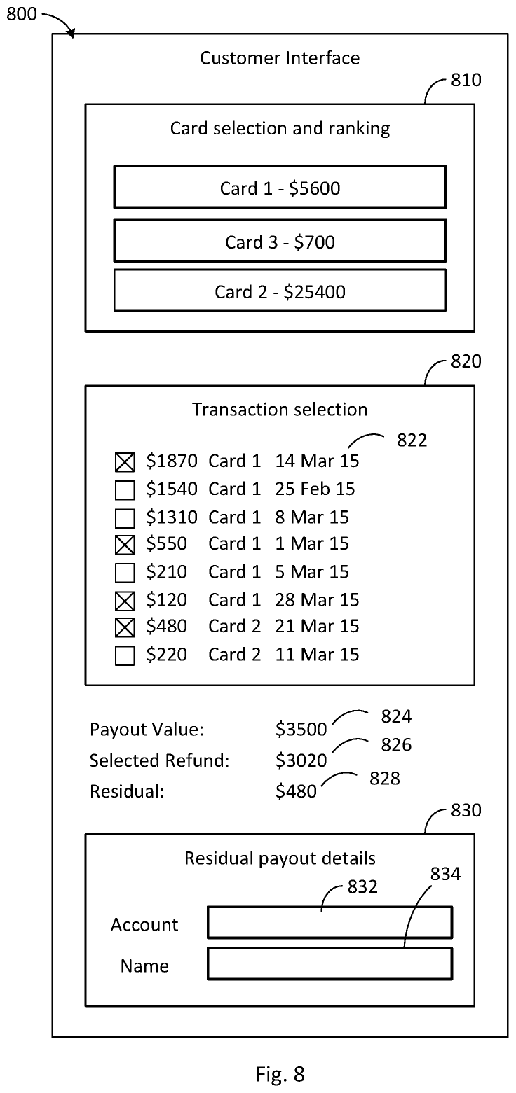

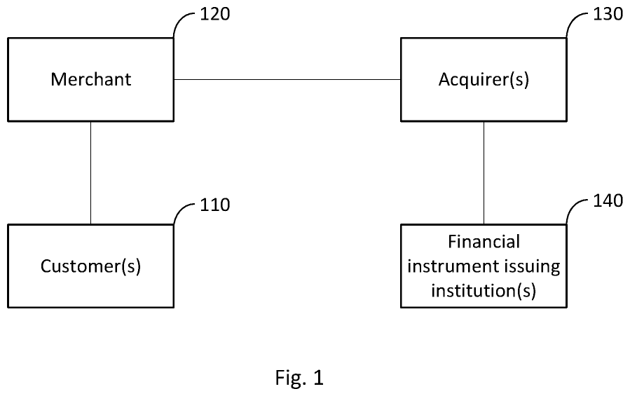

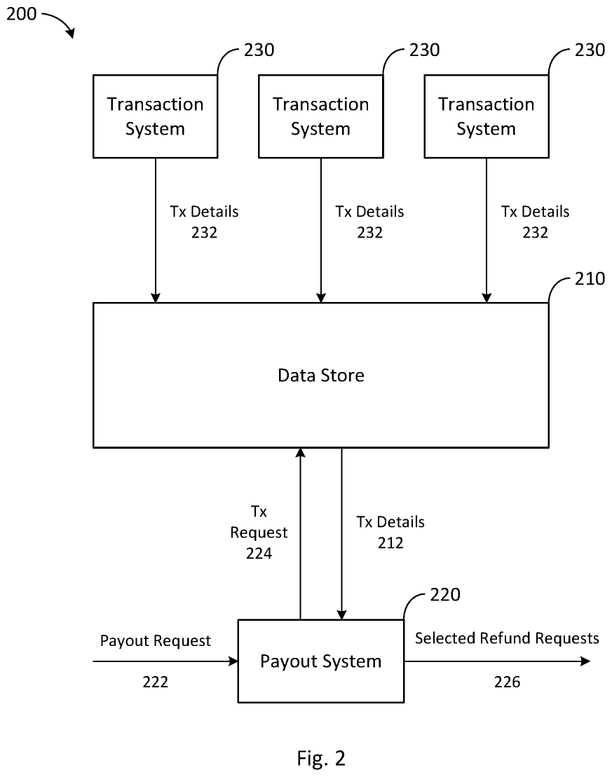

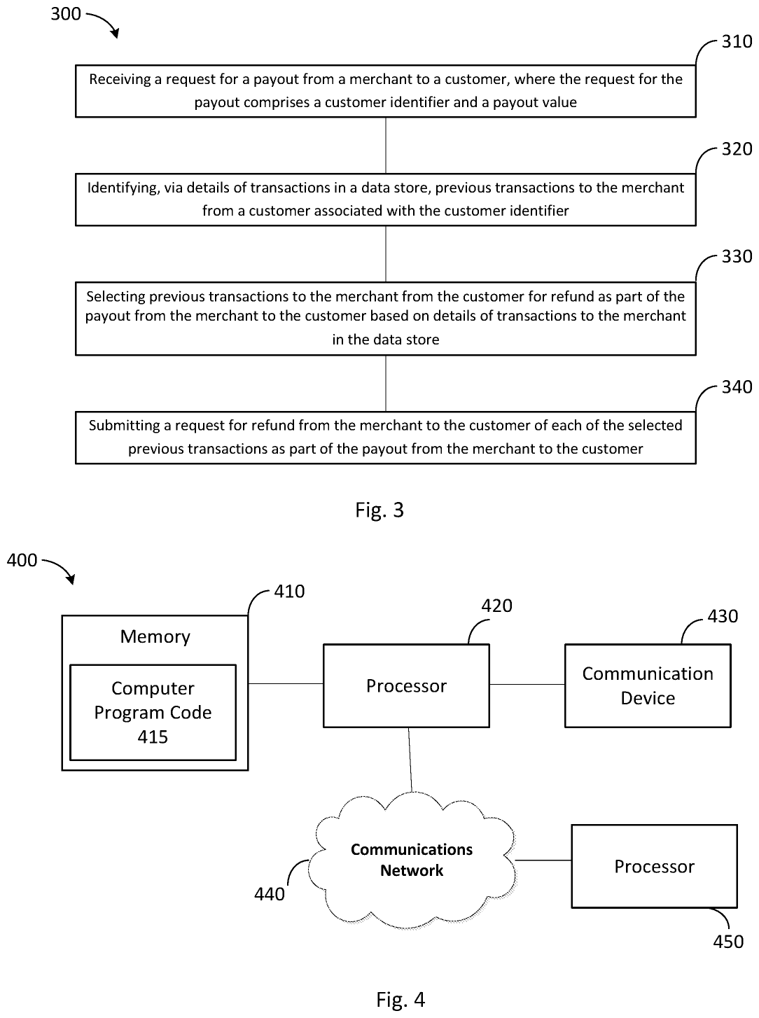

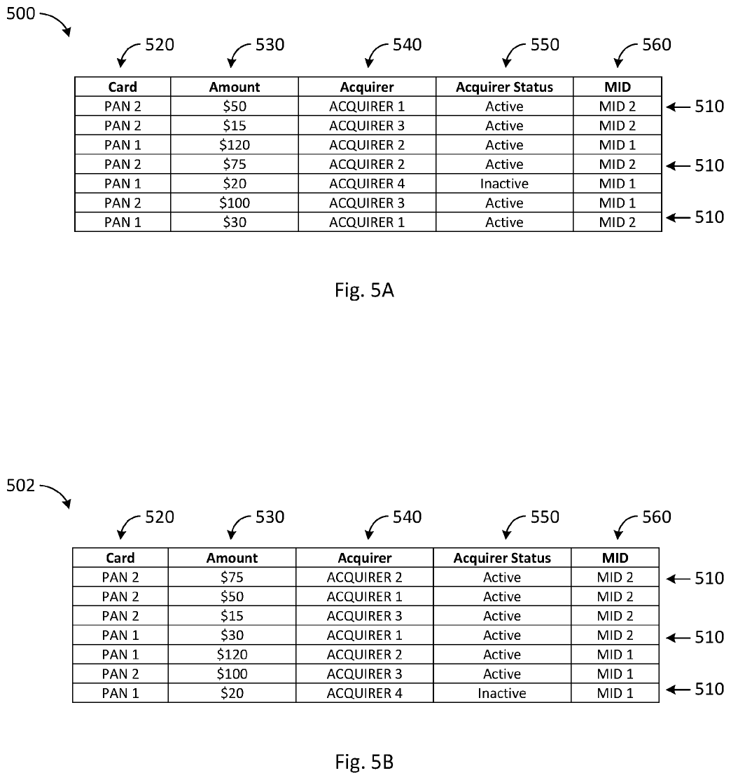

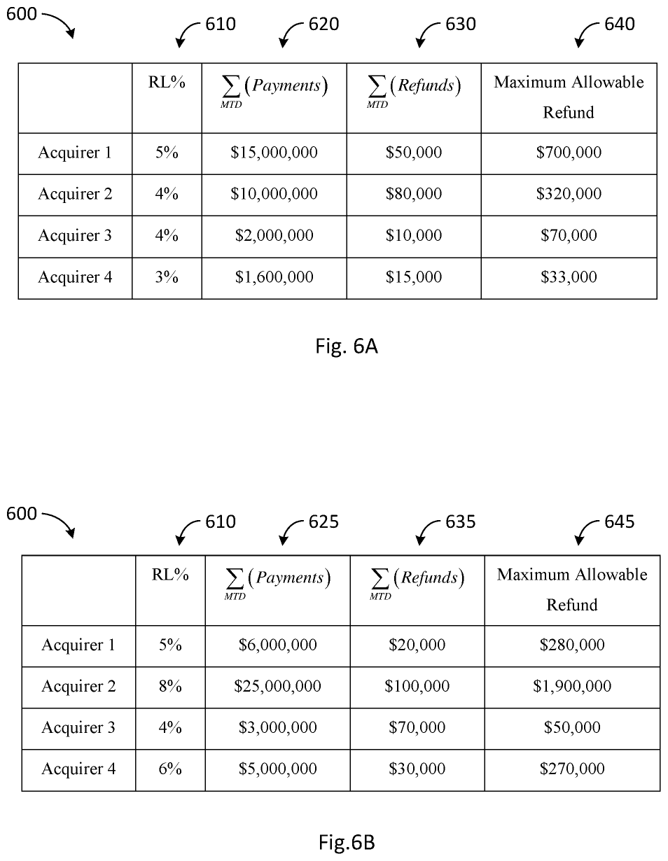

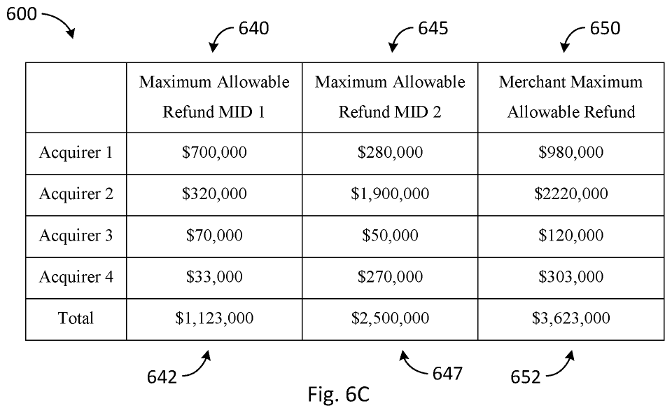

FIG. 6A illustrates example maximum available refunds per acquirer for a first merchant identifier (MID 1) of the merchant as calculated by the processor 420. Column 610 comprises refund limits for each acquirer. Column 620 comprises the aggregate value of transactions for that acquirer for MID 1. Column 630 comprises the aggregate value of refunds for that acquirer for MID 1. Column 640 comprises the maximum available refund for each acquirer for MID 1 based on columns 620, 630 and 640.

FIG. 6B illustrates example maximum available refunds per acquirer for a second merchant identifier (MID 2) of the merchant as calculated by the processor 420. Column 610 again comprises refund limits for each acquirer. Column 625 comprises the aggregate value of transactions for that acquirer for MID 2. Column 635 comprises the aggregate value of refunds for that acquirer for MID 2. Column 645 comprises the maximum available refund for each acquirer for MID 2 based on columns 625, 635 and 645.

FIG. 6C illustrates example maximum available refunds in column 640 for MID 1, maximum available refunds in column 645 for MID 2, and maximum available refunds in column 650 for the merchant for each acquirer, as calculated by the processor 420. For example, the processor 420 may sum all the maximum available refunds per MID for each acquirer to determine a maximum available refund for the merchant for each acquirer. The processor 420 may sum the maximum available refunds for each acquirer for a given MID to determine a maximum available refund for that MID, as shown in 642 and 647. The processor 220 may sum the maximum available refunds per acquirer for all acquirers used by the merchant, or the maximum available refunds per MID for all MIDs used by the merchant, to determine a maximum available refund for the merchant shown in 652.

In one example, the merchant may request their payment gateway and acquirers to process tens or hundreds of thousands of transactions against different cards each day. Each payment is recorded in the data store 210. The aggregate value of transactions processed by MID (month to date) may change rapidly and significantly in fractions of a second, as each new payment is processed. Similarly, refunds may be processed as part of payouts and may also be processed manually by the merchant. Multiple customers may also seek payouts within contemporaneous timeframes.

To address such demand, the processor 420 may store each relevant maximum available refund amount in the memory 410 and/or the data store 210 and recalculate each relevant maximum available refund whenever a transaction or refund is performed. To assist with such calculations and/or the other methods performed herein, the processor 420 may record and store in the memory 410 and/or the data store 210 by reference to both MID and acquirer one or more of the following: all refunds processed for the month to date, refunds processed as a historic aggregate total for prior months, refunds processed against any card by total and by date, refunds processed by MID to any customer in total and by date. Similarly, the processor 420 may record and store in the memory 410 and/or the data store 210, intermediate values such as the sum of payments for month to date. Such values may be updated in the memory 420 each time a new transaction is performed. This may enable faster recalculation of the maximum available refunds, such that an up-to-date value may be used when determining a means for payout.

### User Interfaces

In some embodiments, the processor 420 selects the one or more of the previous transactions to the merchant from the customer based on selection criteria. A merchant interface may be displayed to the merchant to select the selection criteria. In some examples the merchant's processor 450 displays the merchant interface. For example, the selection criteria may include sorting by a nominated or preferred card (or sequence of cards), or by the highest transaction value, or the oldest transaction, or the MID with the least refund capacity, or the MID with the most refund capacity, or selecting only transactions from certain cards, or where a funding currency matches a payout currency, or where a favourable exchange rate is applicable, or a combination of these. In some examples, the processor 420 selects the one or more previous transactions based upon the highest transaction value first to mitigate chargeback risk for the merchant.

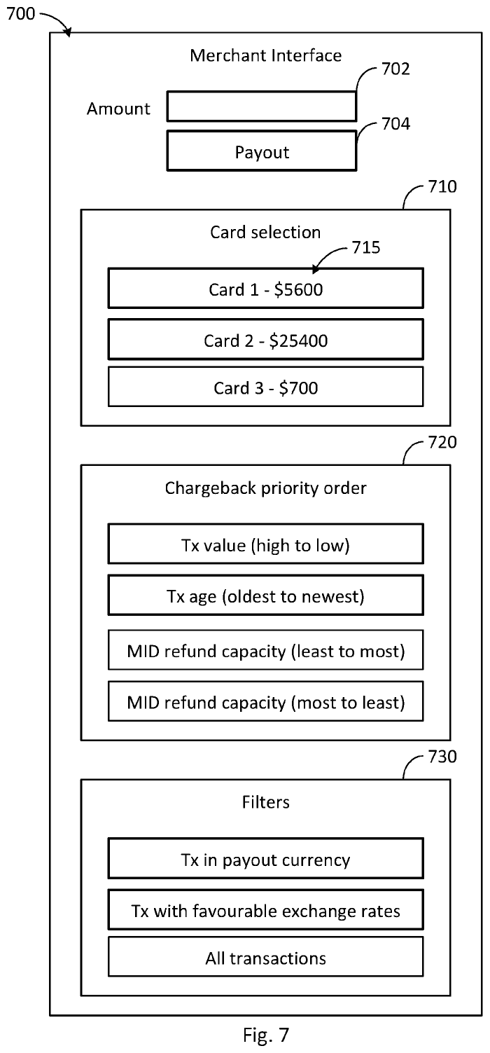

FIG. 7 illustrates a first example interface 700 that may be presented to the merchant, for example, via a display on a merchant computing device or processor 450. The first example interface 700 comprises a payout value field 702 to receive input of a payout value from the merchant. The first example interface 700 comprises a payout button 704 to initiate a request for payout from the merchant to the customer. In some examples, the payout value field 702 and the payout button 704 are not provided in the interface, such as when the interface is provided for general configuration of payouts for a customer, or when a payout value is automatically selected, such as when the payout value is a winning for a game of chance or skill.

The first example interface 700 comprises a card selection interface 710 via which cards to use for the payout can be selected by the merchant. “Card 1” and “Card 2” are shown as selected. This means the previous transactions will only be selected by the processor 420 for refund from transactions involving these two cards. In one example, selection of a specific card may be disabled by the processor 420, if the processor 420 has determined that the card has expired. In another example, the processor 420 will only selected previous transactions for refund from selected cards that have not expired.

The card selection interface 710 comprises a value 715 that may be refunded on each card. This may assist the merchant in determining which cards to select. The first example interface 700 comprises a refund priority order interface 720 via which sorting criteria can be selected and reordered by the merchant. Two sorting criteria are shown as having been selected, namely, sort by transaction value from high to low then sort by transaction age from oldest to newest. The first example interface 700 comprises a filters interface 730 via which filters for the selection process can be selected by the merchant. Two filters are shown as having been selected, namely, limit the selection to transactions that are in the same currency as the payout and transactions that have favourable exchanges rates if not in the same currency as the payout.

In some embodiments, a customer interface may be displayed to the customer to select the selection criteria. The customer interface may be displayed on a customer computing device associated with the customer. The selection criteria may include sorting by a nominated or preferred card (or sequence of cards), or by the highest transaction value, or, the oldest transaction, or selecting only transactions from certain cards, or where a funding currency matches a payout currency, or where a favourable exchange rate is applicable, or a combination of these. For example, a similar interface to the first example interface 700 can be presented to the customer via a display on a customer computing device. The customer interface may also enable the customer to provide a preferred sequence of payout by card or by transaction.

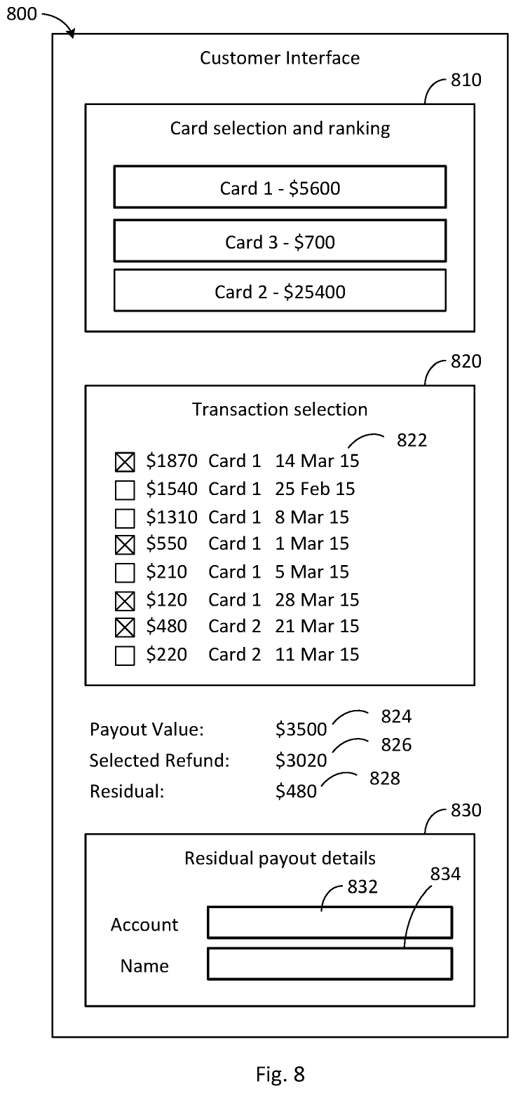

FIG. 8 illustrates a second example interface 800 that may be presented to the customer, for example, via a display on the customer computing device. The second example interface 800 comprises a card selection interface 810 via which cards to use for the payout can be selected by the customer. “Card 1” and “Card 3” are shown as selected. This means the previous transactions will only be selected for refund by the processor 420 from transactions involving these two cards. As in the first example interface 700, selection of a specific card may be disabled by the processor 420, if the processor 420 has determined that the card has expired. The processor 420 may also only enable selection of previous transactions for refund from selected cards that have not expired.

The second example interface 800 comprises a transaction selection interface 820 via which previous transaction to use for the payout can be selected by the customer. Four transactions 822 are shown as selected. The second example interface 800 displays the payout value 824, the total value of the transactions selected for refund 826, and a residual 828 of the payout value 824 that will remain after the selected transactions are refunded. In some examples, the transaction selection interface 820 may disable the selection of further transactions if the sum to the selected transactions is greater than or equal to the payout value. In some examples, the transaction selection interface 820 may allow transactions to be partially refunded, for example, where the sum of the selected transactions is more than the payout value and/or where part of a previous transaction has already been refunded. In some examples, a similar transaction selection interface may be included in the interface presented to the merchant.

The second example interface 800 comprises a payout details interface 830 into which the customer can enter SWIFT, SEPA, bank to bank transfer details, or other account details for payout of the residual. The second example interface 800 comprises an account input field 832 to receive an account identifier to identify an account to which the residual is paid out, and a name input field 834 to receive a name associated with the account. It will be appreciated that the payout details interface may include any fields necessary to receive the details required to perform a payout to a chosen account. In one example, the payout details may be stored in the memory 410 or the data store 210 to implement future payouts. The payout details interface 830 may then enable selection of stored payout details or accounts by the customer.

The interface 700 and/or the interface 800 may be, for example, an online interface, such as a web app or webpage, or mobile interface such as an app, or other computer software. The interface 700 and/or the interface 800 may also be implemented in other forms.

The payout described herein may be a payout on behalf of a merchant providing a service, or for a merchant such as a financial institution, insurance company, digital currency processor, casino, betting agency, wagering company, payment processor, stock broker, securities or futures dealer, eMoney institution, eWallet operator, bullion dealer, card scheme (such as Visa, Mastercard, American Express, JCB, China UnionPay), or any other entity that finds it desirable to refund a customer a sum of monies back to one or more financial instruments, such as a card.

In embodiments discussed herein, it is assumed that a merchant has accepted more than one payment from one or more financial instruments presented by a customer, the details of which may be stored in the data store 210. The payments may have been to fund a service provided by the merchant, such as a games of skill or chance, or trading.

For convenience, the embodiments may also be described using cards such as credit cards or debit cards as a financial instrument. However, it is not intended that the scope of the invention be limited in this manner as the invention has broad application to other financial instruments including virtual cards, prepaid cards, and stored value cards.

Also for convenience, the embodiments are generally described with reference to a customer, who may alternatively be referred to as a person, purchaser, consumer, gambler, trader, punter, payer, cardholder or the originator of the transaction. The embodiments are also described with reference to a merchant, who may alternatively referred to as the payee, or online operator. These terms are used to provide familiar examples and are not intended to limit the scope of the disclosure to a specific type of entity that receives payments and issues payouts.

The embodiments of the invention are primarily applicable in the context of online purchases of an item or service from a merchant (e.g., a vendor of physical or virtual goods, or a provider of services, also referred to as payee) by a customer who originates an online Card Not Present (CNP) transaction. However, it is not intended that the scope of the invention be limited in this manner as the invention has broad application to other CNP transactions, including Mail Order and Telesales Orders (“MOTO”), and for other merchant types and categories.

It is intended that the payout system either interfaces to one or more payment gateways, card processors, card schemes, OCT services, SEPA transfer, SWIFT transfer, and/or bank to bank transfer via a software interface, or, the payout systems and methods are incorporated, embedded or referenced into a software stack of payment processors, payment gateways and/or card schemes.

Persons skilled in the art of payment processing will have the knowledge to perform such integration into the payment processors, payment gateways, acquiring institutions, and/or card schemes or will have the means to access via software interfaces the details for the transactions, such as the transaction identifier, the card data including the card Primary Account Number (PAN) being its 16 or 19 digit unique card number, expiry date, timestamps of transaction, transaction status, authorisation or decline codes, retrieval request number (RRN), original transaction amount, refunded amounts (if any), transaction currency, foreign exchange rate, merchant data, card issuing institution and acquiring institution details.

The systems and methods discussed herein may also be implemented via the optional integration of the payout systems and methods into existing authorisation, clearing, and settlement processes of the payment gateways, payment processors, payment institutions, financial institutions and/or the card scheme network.

Embodiments described hereinafter may be practised independently or in conjunction with the various methods and checks referred to in the foregoing background section.

The embodiments described herein may benefit the merchant by partially or completely removing the need to strictly identify a customer to perform a transaction. For example, the merchant can refund existing transactions when performing a payout, and therefore does not require the same level of processing for authentication as would be required for a payout by a new independent transaction. The customer may also benefit as payouts may be processed faster, even nearly instantaneously. That is, the refund process is relatively quick in processing funds back to a card holder, when compared to making a further transaction. For each transaction that is refunded back to “zero”, the opportunity for a chargeback is also removed which reduces CNP fraud risk for the merchant when authenticating transactions and making payouts.

The cardholder may be displayed the total amount to be refunded back to each card and therefore can select cards for refunds depending on their needs. In some embodiments, the cardholder may nominate which card or cards and order of preference. In some embodiments, the cardholder may choose from a list of available transactions, and nominate which transactions are to be refunded and the sequence, until the payout or value of transactions are exhausted. Where there is insufficient capacity to refund back to cards, this problem may be addressed by automatically paying out a remainder of the payout using conventional means including OCT, SEPA, SWIFT, and bank to bank transfers, or by delaying payout until more transactions can be refunded which may still provide quicker payout of money to the customer than conventional means.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1-21. (canceled)

22. A payout processing system comprising:
a data store to store details of transactions;
a processor in communication with the data store, the processor configured to perform the following:
receive a request for a payout from a merchant to a customer, the request for the payout comprising a customer identifier and a payout value;
identify, via the details of transactions in the data store, all previous transactions to the merchant from a customer associated with the customer identifier;
select one or more transactions from the previous transactions to the merchant from the customer for refund as part of the payout from the merchant to the customer based on the details of transactions to the merchant in the data store; and
submit a request for refund from the merchant to the customer of each of the selected previous transactions as part of the payout from the merchant to the customer.

23. The system of claim 22, wherein the processor is configured to:
identify, via the details of transactions from the data store, one or more acquirers associated with the previous transactions to the merchant from the customer;
calculate, based on the details of transactions stored in the data store, a maximum available refund from the merchant for each acquirer; and
select the selected previous transactions based on the maximum available refund.

24. The system of claim 23, wherein the processor is configured to calculate the maximum available refund from the merchant for each acquirer by:
determining an acquirer aggregate transaction value for the merchant by summing a transaction value of each of the transactions to the merchant that are associated with the acquirer within a refund window period;
determining an acquirer aggregate refund value by summing the amounts refunded from the merchant that are associated with the acquirer within the refund window period; and
calculating the maximum available refund from the merchant for each acquirer as: acquirer refund limit (%)×acquirer aggregate transaction value−acquirer aggregate refund value.

25. The system of claim 23, wherein the processor is configured to calculate a maximum available refund from the merchant for each acquirer by:
calculating, based on the details of transactions stored in the data store, a maximum available refund per merchant identifier (MID) of the merchant for each acquirer.

26. The system of claim 25, wherein the processor is configured to:
generate an array of the previous transactions to the merchant from the customer; and
sort the array by MID associated with each previous transaction from highest to lowest based on the maximum available refund for each MID; and
select the selected previous transactions to the merchant from the customer according to the sorted order of the array.

27. The system of claim 26, wherein the processor is configured to:
sort the array by transaction value of each previous transaction for each MID from highest value to lowest value; and
select the selected previous transactions to the merchant from the customer according to the sorted order of the array.

28. The system of claim 26, wherein the processor is configured to:
sort the array by a date of each previous transaction for each MID from highest value to lowest value; and
select the selected previous transactions to the merchant from the customer according to the sorted order of the array.

29. The system of claim 23, wherein the processor is configured to:
determine that a sum of the maximum available refund from the merchant for each acquirer associated with the previous transactions is less than the payout value; and
determine at a later time that one or more further transactions to the merchant that are associated with the one or more acquirers have been processed; and
submit a request for refund of one or more of the further previous transactions as part of the payout from the merchant to the customer.

30. The system of claim 22, wherein the processor is configured to:
determine that a sum of the transaction values of the previous transactions to the merchant from the customer is less than the payout value, and
submit a request to transfer of a remainder of the payout value from the merchant to the customer.

31. The system of claim 30, wherein the processor is configured to automatically submit a request to transfer the remainder of the payout value via an original credit transfer (OCT) to a card associated with one of the previous transactions.

32. The system of claim 30, wherein the processor is configured to automatically submit a request to transfer the remainder of the payout value via an alternative payment means to an account identified by the customer.

33. The system of claim 30, wherein the processor is configured to submit the request to transfer of the remainder of the payout value from the merchant to the customer to one of the following:
an acquirer used for a previous transaction associated with the payout request;
a card identified by the customer; and
a bank account identified by the customer.

34. The system of claim 30, wherein the processor is configured to determine one or more payout means associated with the customer identifier, and identify one or more of the payout means in the request to transfer the remainder of the payout value from the merchant to the customer.

35. The system of claim 30, wherein the processor is configured to:
determine, via the data store, one or more of the following payout details associated with the customer identifier: payment methods, account details, and previous refund means used by a customer to fund payments; and
generate the request to transfer the remainder of the payout value from the merchant to the customer based on the payout details.

36. The system of claim 22, wherein the processor is configured to store transaction details in the data store when a transaction is processed.

37. The system of claim 22, wherein the processor is configured to retrieve one or more of the following transaction details from the data store for one or more transactions:
a transaction time;
a transaction identifier;
a customer identifier;
an acquirer identifier;
a merchant identifier; and
a transaction value.

38. The system of claim 22, wherein the processor is configured to retrieve one or more of the following transaction details from the data store for one or more transactions:
a refund value;
a terminal identifier;
an authorisation and authentication code generated by a payment network for the transaction;
a time when the acquirer associated with the transaction was last active;
an account or card identifier; and
a currency used for the transaction.

39. The system of claim 22, wherein the payout processing system interfaces with or forms part of a payment network or a transaction processing network.

40. The system of claim 22, wherein the previous transactions are transactions that were processed within a refund period.

41. A payout processing method to be performed by a computer to execute a payout of a payout value to a customer, the method comprising:
receiving a request for a payout from a merchant to a customer, the request for the payout comprising a customer identifier and a payout value;
identifying, via a data store including transaction details of transactions, all previous transactions to the merchant from a customer associated with the customer identifier;
selecting one or more transactions from the previous transactions to the merchant from the customer for refund as part of the payout from the merchant to the customer based on the details of transactions to the merchant in the data store; and
submitting a request for refund from the merchant to the customer of each of the selected previous transactions as part of the payout from the merchant to the customer.

42. Computer readable media comprising computer code components that when executed by a processor cause the processor to perform the following:
receive a request for a payout from a merchant to a customer, the request for the payout comprising a customer identifier and a payout value;
identify, via a data store including transaction details of transactions, all previous transactions to the merchant from a customer associated with the customer identifier;
select one or more transactions from the previous transactions to the merchant from the customer for refund as part of the payout from the merchant to the customer based on the details of transactions to the merchant in the data store; and
submit a request for refund from the merchant to the customer of each of the selected previous transactions as part of the payout from the merchant to the customer.
